(19) United States
(12) Patent Application Publication
(10) Pub. No.: US 2012/0050495 A1
(43) Pub. Date: Mar. 1, 2012

(54) METHOD AND SYSTEM FOR MULTI-VIEW 3D VIDEO RENDERING

(76) Inventors: Xuemin Chen, Rancho Santa Fe, CA (US); Nambi Seshadri, Irvine, CA (US); Jeyhan Karaoguz, Irvine, CA (US); Chris Boross, Sunnyvale, CA (US)

(21) Appl. No.: 13/077,930

(22) Filed: Mar. 31, 2011

Related U.S. Application Data
(60) Provisional application No. 61/377,867, filed on Aug. 27, 2010.
(60) Provisional application No. 61/439,301, filed on Feb. 3, 2011.

(51) Int. Cl. H04N 13/02

(52) U.S. Cl. 348/48; 348/E13.074

(57) ABSTRACT

An array of monoscopic sensing devices comprising one or more image sensors and one or more depth sensors captures a 2D monoscopic video and captures corresponding depth information at a plurality different view angles for the captured 2D video. The captured 2D monoscopic video and the captured depth information at the different view angles are utilized to compose a 3D video. The captured 2D video and the captured depth information at the different view angles are compressed utilizing MVC. The compressed 2D monoscopic video and the compressed depth information at the different view angles are transcoded into a Blu-ray left view stream and a right Blu-ray right view stream, respectively, for storage. Depending on display configuration, the stored Blu-ray left view stream and the stored right Blu-ray right view stream are decoded utilizing MVC to compose a single view 3D video and/or a multi-view 3D video for 3D video rendering.

### CROSS-REFERENCE TO RELATED APPLICATIONS/INCORPORATION BY REFERENCE

This patent application makes reference to, claims priority to, and claims benefit from U.S. Provisional Application Ser. No. 61/377,867, which was filed on Aug. 27, 2010.

This patent application makes reference to, claims priority to, and claims benefit from U.S. Provisional Application Ser. No. 61/439,301, which was filed on Feb. 03, 2011.

This application also makes reference to:

U.S. Patent Application Ser. No. 61/439,193 filed on Feb. 3, 2011;
U.S. Patent Application Ser. No. (Attorney Docket No. 23461US03) filed on March 31, 2011;
U.S. Patent Application Ser. No. 61/439,274 filed on Feb. 3, 2011;
U.S. Patent Application Ser. No. (Attorney Docket No. 23462US03) filed on March 31, 2011;
U.S. Patent Application Ser. No. 61/439,283 filed on Feb. 3, 2011;
U.S. Patent Application Ser. No. (Attorney Docket No. 23463US03) filed on March 31, 2011;
U.S. Patent Application Ser. No. 61/439,130 filed on Feb. 3, 2011;
U.S. Patent Application Ser. No. (Attorney Docket No. 23464US03) filed on March 31, 2011;
U.S. Patent Application Ser. No. 61/439,290 filed on Feb. 3, 2011;
U.S. Patent Application Ser. No. (Attorney Docket No. 23465US03) filed on Mar. 31, 2011;
U.S. Patent Application Ser. No. 61/439,119 filed on Feb. 3, 2011;
U.S. Patent Application Ser. No. (Attorney Docket No. 23466US03) filed on Mar. 31, 2011;
U.S. Patent Application Ser. No. 61/439,297 filed on Feb. 3, 2011;
U.S. Patent Application Ser. No. (Attorney Docket No. 23467US03) filed on Mar. 31, 2011;
U.S. Patent Application Ser. No. 61/439,201 filed on Feb. 3, 2011;
U.S. Patent Application Ser. No. 61/439,209 filed on Feb. 3, 2011;
U.S. Patent Application Ser. No. (Attorney Docket No. 23471 US03) filed on Mar. 31, 2011;
U.S. Patent Application Ser. No. 61/439,113 filed on Feb. 3, 2011;
U.S. Patent Application Ser. No. (Attorney Docket No. 23472US03) filed on Mar. 31, 2011;
U.S. Patent Application Ser. No. 61/439,103 filed on Feb. 3, 2011;
U.S. Patent Application Ser. No. (Attorney Docket No. 23473US03) filed on Mar. 31, 2011;
U.S. Patent Application Ser. No. 61/439,083 filed on Feb. 3, 2011;
U.S. Patent Application Ser. No. (Attorney Docket No. 23474US03) filed on Mar. 31, 2011;

Each of the above stated applications is hereby incorporated herein by reference in its entirety.

### FIELD OF THE INVENTION

Certain embodiments of the invention relate to video processing. More specifically, certain embodiments of the invention relate to a method and system for multi-view 3D video rendering.

### BACKGROUND OF THE INVENTION

Digital video capabilities may be incorporated into a wide range of devices such as, for example, digital televisions, digital direct broadcast systems, digital recording devices, and the like. Digital video devices may provide significant improvements over conventional analog video systems in processing and transmitting video sequences with increased bandwidth efficiency.

Video content may be recorded in two-dimensional (2D) format or in three-dimensional (3D) format. In various applications such as, for example, the DVD movies and the digital TV, a 3D video is often desirable because it is often more realistic to viewers than the 2D counterpart. A 3D video comprises a left view video and a right view video. A 3D video frame may be produced by combining left view video components and right view video components, respectively.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for multi-view 3D video rendering, substantially as illustrated by and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary video communication system that is operable to support multi-view 3D video rendering, in accordance with an embodiment of the invention.

FIG. 2 is a block diagram that illustrates creating a multi-view 3D video for 3D video rendering, in accordance with an embodiment of the invention.

FIG. 3 is a flow chart illustrating exemplary steps that may be performed to compress a 2D monoscopic video and corresponding depth information captured at different view angles utilizing multi-view video coding (MVC), in accordance with an embodiment of the invention.

FIG. 4 is a flow chart illustrating exemplary steps that may be performed for multi-view 3D video rendering, in accordance with an embodiment of the invention.

### DETAILED DESCRIPTION OF THE INVENTION

Certain embodiments of the invention may be found in a method and system for multi-view 3D video rendering. In various embodiments of the invention, an array of monoscopic sensing devices such as the monoscopic video camera array comprising one or more image sensors and one or more depth sensors is operable to capture a 2D monoscopic video and to capture corresponding depth information, at a plurality different view angles, for the captured 2D video. The captured 2D monoscopic video and the captured corresponding depth information at the different view angles may be utilized to compose a 3D video. The captured 2D video and the captured corresponding depth information at the different view angles may be compressed utilizing Multiview Video Coding (MVC). The compressed 2D video and the compressed depth information at the different view angles may be transcoded or converted into a Blu-ray left view stream and a Blu-ray right view stream, respectively. The Blu-ray left view stream and the Blu-ray right view stream may be stored for 3D video rendering and/or playback. In this regard, the stored Blu-ray left view stream and the stored Blu-ray right view stream may be decoded through MVC. Depending on display configuration and/or user preferences, a single view 3D video and/or a multi-view 3D video may be composed from the decoded Blu-ray left view stream and the decoded Blu-ray right view stream. With a single view 3D video for a specific view angle, depth information corresponding to the specific view angle may be extracted from the decoded Blu-ray right view stream. The resulting extracted depth information may be combined with the decoded Blu-ray left view stream to compose a single view 3D video for the specific view angle. With a multi-view 3D video for multiple view angles, depth information corresponding to the multiple view angles may be extracted from the decoded Blu-ray right view stream. A multi-view 3D video may be composed for 3D video rendering by combining the extracted depth information with the decoded Blu-ray left view stream.

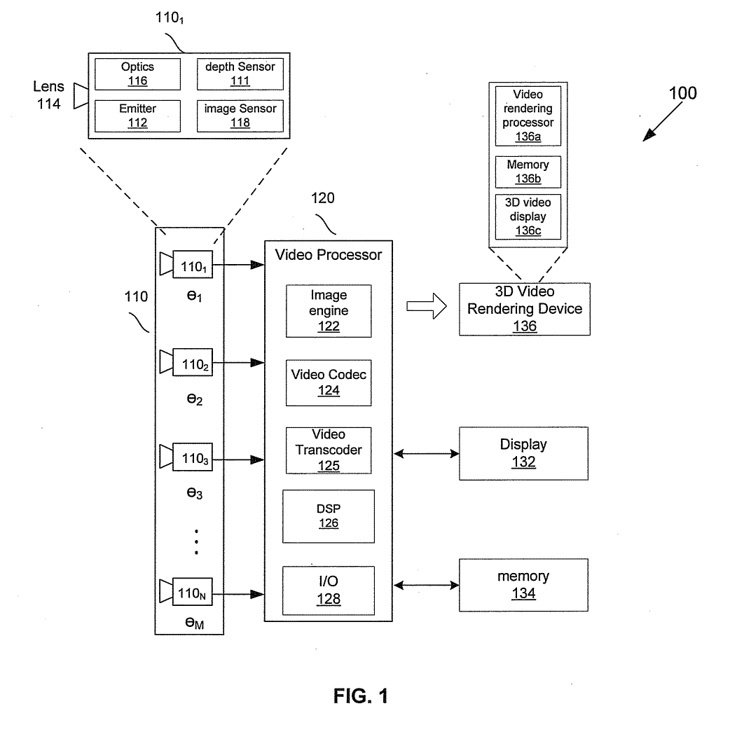

FIG. 1 is a diagram illustrating an exemplary video communication system that is operable to support multi-view 3D video rendering, in accordance with an embodiment of the invention. Referring to FIG. 1, there is shown a video communication system 100. The video communication system 100 comprises a monoscopic video camera array 110, a video processor 120, a display 132, a memory 134 and a 3D video rendering device 136.

The monoscopic video camera array 110 may comprise a plurality of single-viewpoint or monoscopic video cameras 110₁₋₁₁₀_{N}, where the parameter N is the number of monoscopic video cameras. Each of the monoscopic video cameras 110₁-110_{N} may be placed at a certain view angle with respect to a target scene in front of the monoscopic video camera array 110. Each of the monoscopic video cameras 110₁-110_{N} may operate independently to collect or capture information for the target scene. The monoscopic video cameras 110₁-110_{N} each may be operable to capture 2D image data and corresponding depth information for the target scene. A 2D video comprises a collection of 2D sequential images. 2D image data for the 2D video specifies intensity and/or color information in terms of pixel position in the 2D sequential images. Depth information for the 2D video represents distance to objects visible in terms of pixel position in the 2D sequential images. The monoscopic video camera array 110 may provide or communicate the captured 2D image data and the captured corresponding depth information to the video processor 120 for further process to support 2D and/or 3D video rendering and/or playback, for example.

A monoscopic video camera such as the monoscopic video camera 110₁ may comprise a depth sensor 111, an emitter 112, a lens 114, optics 116, and one or more image sensors 118. The monoscopic video camera 110₁ may comprise suitable logic, circuitry, interfaces, and/or code that may be operable to capture a 2D monoscopic image via a single viewpoint corresponding to the lens 114. The monoscopic video camera 110₁ may be operable to collect corresponding depth information for the captured 2D image via the depth sensor 111.

The depth sensor 111 may comprise suitable logic, circuitry, interfaces, and/or code that may be operable to detect electromagnetic (EM) waves in the infrared spectrum. The depth sensor 111 may determine or detect depth information for the objects in the target scene based on corresponding infrared EM waves. For example, the depth sensor 111 may sense or capture depth information for the objects in the target scene based on time-of-flight of infrared EM waves transmitted by the emitter 112 and reflected from the objects back to the depth sensor 111.

The emitter 112 may comprise suitable logic, circuitry, interfaces, and/or code that may be operable to produce and/or transmit electromagnetic waves in infrared spectrum, for example.

The lens 114 is an optical component that may be utilized to capture or sense EM waves. The captured EM waves in the visible spectrum may be focused through the optics 116 on the image sensor(s) 118 to form or generate 2D images for the target scene. The captured EM waves in the infrared spectrum may be utilized to determine corresponding depth information for the captured 2D images. For example, the captured EM waves in the infrared spectrum may be focused through the optics 116 on the depth sensor 111 to capture corresponding depth information for the captured 2D images.

The optics 116 may comprise optical devices for conditioning and directing EM waves received via the lens 114. The optics 116 may direct the received EM waves in the visible spectrum to the image sensor(s) 118 and direct the received EM waves in the infrared spectrum to the depth sensor 111, respectively. The optics 116 may comprise one or more lenses, prisms, luminance and/or color filters, and/or mirrors.

The image sensor(s) 118 may each comprise suitable logic, circuitry, interfaces, and/or code that may be operable to sense optical signals focused by the lens 114. The image sensor(s) 118 may convert the optical signals to electrical signals so as to capture intensity and/or color information for the target scene. Each image sensor 118 may comprise, for example, a charge coupled device (CCD) image sensor or a complimentary metal oxide semiconductor (CMOS) image sensor.

The video processor 120 may comprise suitable logic, circuitry, interfaces, and/or code that may be operable to handle and control operations of various device components such as the monoscopic video camera array 110, and manage output to the display 132 and/or the 3D video rendering device 136. The video processor 120 may comprise an image engine 122, a video codec 124, a digital signal processor (DSP) 126 and an input/output (I/O) 128. The video processor 120 may utilize the image sensors 118 to capture 2D monoscopic image (raw) data. The video processor 120 may utilize the depth sensor 111 to collect or detect corresponding depth information for the captured 2D monoscopic image data. In an exemplary embodiment of the invention, corresponding depth information at different view angles may be collected or captured for the same captured 2D monoscopic image data. The video processor 120 may process the captured 2D monoscopic image data and the captured corresponding depth information via the image engine 122 and the video codec 124, for example. In this regard, the video processor 120 may be operable to compose a 2D and/or 3D image from the processed 2D image data and the processed corresponding depth information for 2D and/or 3D video rendering and/or playback. The composed 2D and/or 3D image may be presented or displayed to a user via the display 132 and/or the 3D video rendering device 136. The video processor 120 may also be operable to enable or allow a user to interact with the monoscopic video camera array 110, when needed, to support or control video recording and/or playback.

The image engine 122 may comprise suitable logic, circuitry, interfaces, and/or code that may be operable to receive 2D image data captured via the monoscopic video cameras 110₁-110_{N} and provide or output view-angle dependent 2D image data and corresponding view-angle dependent depth information, respectively. In this regard, the image engine 122 may model or map 2D monoscopic image data and corresponding depth information, captured by the monoscopic video camera array 110, to an image mapping function in terms of view angles and lighting conditions. Lighting conditions for the scene of the captured 2D monoscopic image data may comprise information such as lighting and reflecting direction, and/or contrasting density. The image mapping function may convert the captured 2D monoscopic image data and the captured corresponding depth information to different set of 2D image data and corresponding depth information depending on view angles. The image mapping function may be determined, for example, by matching or fitting the captured 2D monoscopic image data and the captured corresponding depth information to known view angles and associated lighting conditions of the monoscopic video cameras 110₁-110_{N}, The image engine 122 may utilize the determined image mapping function to map or convert the captured 2D monoscopic image data and the captured corresponding depth information to view-angle dependent 2D image data and view-angle dependent depth information, respectively.

The video codec 124 may comprise suitable logic, circuitry, interfaces, and/or code that may be operable to perform video compression and/or decompression. The video codec 124 may utilize various video compression and/or decompression algorithms such as video compression and/or decompression algorithms specified in MPEG-2, and/or other video formats for video coding.

The video transcoder 125 may comprise suitable logic, circuitry, interfaces, and/or code that may be operable to convert a compressed video signal into another one with different format such as different compression standard and/or Blu-ray Disc (BD) format. Blu-ray, also known as Blu-ray Disc (BD), is the name of a next-generation optical disc format. The Blu-ray format may enable recording, rewriting and playback of high-definition video (HD), as well as storing large amounts of data.

The DSP 126 may comprise suitable logic, circuitry, interfaces, and/or code that may be operable to perform signal processing of image data and depth information supplied from the monoscopic video camera array 110.

The I/O module 128 may comprise suitable logic, circuitry, interfaces, and/or code that may enable the monoscopic video camera array 110 to interface with other devices in accordance with one or more standards such as USB, PCI-X, IEEE 1394, HDMI, DisplayPort, and/or analog audio and/or analog video standards. For example, the I/O module 128 may be operable to communicate with the image engine 122 and the video codec 124 for a 2D and/or 3D video for a given user's view angle, output the resulting 2D and/or 3D video, read from and write to cassettes, flash cards, or other external memory attached to the video processor 120, and/or output video externally via one or more ports such as a IEEE 1394 port, a HDMI and/or an USB port for transmission and/or rendering.

The display 132 may comprise suitable logic, circuitry, interfaces, and/or code that may be operable to display images to a user. The display 132 may comprise a liquid crystal display (LCD), a light emitting diode (LED) display and/or other display technologies on which images captured via the monoscopic video camera array 110 may be displayed to the user at a given user's view angle.

The memory 134 may comprise suitable logic, circuitry, interfaces and/or code that may be operable to store information such as executable instructions and data that may be utilized by the monoscopic video camera array 110. The executable instructions may comprise various video compression and/or decompression algorithms utilized by the video codec 124 for video coding. The data may comprise captured video and/or coded video. The memory 134 may comprise RAM, ROM, low latency nonvolatile memory such as flash memory and/or other suitable electronic data storage.

The 3D video rendering device 136 may comprise suitable logic, circuitry, interfaces, and/or code that may be operable to render images supplied from the monoscopic video camera array 110. The 3D video rendering device 136 may be coupled to the video processor 120 internally or externally. The 3D video rendering device 136 may be adapted to different user's view angles to render 3D video output from the video processor 120.

The 3D video rendering device 136 may comprise a video rendering processor 136a, a memory 136b and a 3D video display 136c. The video rendering processor 136a may comprise suitable logic, circuitry, interfaces, and/or code that may be operable to receive, from the video processor 120, a left view stream and a right view stream for 3D video rendering.

The memory 136b may comprise suitable logic, circuitry, interfaces, and/or code that may be operable to store information such as executable instructions and data that may be utilized by the video rendering processor 136a for 3D video rendering. The executable instructions may comprise various image processing algorithms utilized by the video rendering processor 136a for enhancing 3D effects. The data may comprise 3D videos received from the video processor 120. The memory 136b may comprise RAM, ROM, low latency nonvolatile memory such as flash memory and/or other suitable electronic data storage.

The 3D video display 136c may comprise suitable logic, circuitry, interfaces, and/or code that may be operable to display 3D images to a user. The 3D video display 136c may comprise a liquid crystal display (LCD), a light emitting diode (LED) display and/or other display technologies on which 3D images from the video processor 120 may be displayed to the user at a given view angle.

Although the monoscopic video cameras 110₁-110_{N} and the monoscopic video camera array 110 are illustrated in FIG. 1 to support multi-view 3D video rendering, the invention is not so limited. In this regard, monoscopic video sensing devices and/or an array of monoscopic video sensing devices, which comprise one or more image sensors and one or more depth sensors, may be utilized to support multi-view 3D video rendering without departing from the spirit and scope of the various embodiments of the invention. An image sensor may comprise one or more light emitters and/or one or more light receivers.

In an exemplary operation, a monoscopic video sensing devices such as the monoscopic video camera array 110 may be operable to concurrently or simultaneously capture 2D monoscopic video and corresponding depth information. In this regard, the monoscopic video camera array 110 may be operable to capture depth information for the captured 2D monoscopic video at different view angles. The captured 2D monoscopic video and the captured corresponding depth information at the different view angles may be communicated or provided to the video processor 120. The video processor 120 may be operable to perform video processing on the captured 2D monoscopic video and the captured corresponding depth information, which is captured at the different angles.

In an exemplary embodiment of the invention, the video processor 120 may be operable to input the captured 2D monoscopic video and the captured corresponding depth information at the different view angles to the video codec 124. The video codec 124 may utilize multi-view coding to compress the captured 2D monoscopic video and the captured corresponding depth information at the different view angles, respectively. The video codec 124 may then provide or output a compressed 2D monoscopic video stream and compressed corresponding depth information sequences at the different view angles to the video transcoder 125.

In an exemplary embodiment of the invention, the video transcoder 125 may be operable to transcode the compressed 2D monoscopic video stream and the compressed corresponding depth information at the different view angles to various video formats based on display configuration and/or user preferences. For example, the video transcoder 125 may transcode the compressed 2D monoscopic video stream into a Blu-ray left view stream, and may transcode the compressed corresponding depth information at the different view angles into a Blu-ray right view stream, respectively.

The Blu-ray left view stream and the Blu-ray right view stream may be stored for 3D video rendering.

In an exemplary embodiment of the invention, the 3D video rendering device 136 may be operable to recover or reconstruct the captured 2D monoscopic video and the captured corresponding depth information at the different view angles from the stored Blu-ray left view stream and the stored Blu-ray right view stream for 3D video rendering. In this regard, the 3D video rendering device 136 may decode the stored Blu-ray left view stream and the stored Blu-ray right view stream through MVC.

In an exemplary embodiment of the invention, the 3D video rendering device 136 may be operable to combine the recovered 2D monoscopic video with the recovered corresponding depth information to create or compose a single-view 3D video for a specific view angle. In this regard, the 3D video rendering device 136 may be operable to extract depth information for the specific view angle from the recovered corresponding depth information at the different view angles. The 3D video rendering device 136 may then compose the single-view 3D video by pairing up or combining the recovered 2D monoscopic video with the extracted depth information for the specific view angle. The resulting single-view 3D video may be rendered or displayed via the 3D video display 136c to provide the user with 3D effects corresponding to the specific view angle.

In an exemplary embodiment of the invention, the 3D video rendering device 136 may combine the recovered 2D monoscopic video with the recovered corresponding depth information at the different view angles to create or compose a multi-view 3D video. In this regard, the 3D video rendering device 136 may be operable to compose the multi-view 3D video by combining the recovered 2D monoscopic video with the recovered corresponding depth information at the different view angles. The 3D video rendering device 136 may render the resulting multi-view 3D video to provide the user with multiple 3D effects in terms of the different view angles.

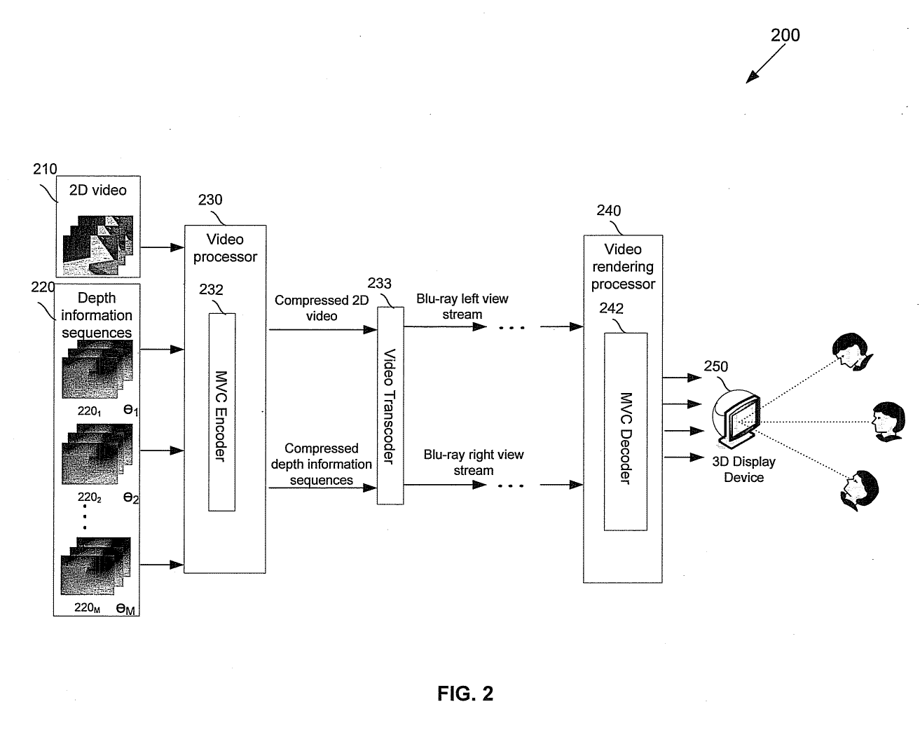

FIG. 2 is a block diagram that illustrates creating a multi-view 3D video for 3D video rendering, in accordance with an embodiment of the invention. Referring to FIG. 2, there is shown a 3D video rendering system 200. The 3D video rendering system 200 comprises a 2D video 210, depth information sequences 220, a video processor 230, a video rendering processor 240 and a 3D display 250.

The 2D video 210 may comprise a 2D monoscopic video captured via the monoscopic video camera 110₁, for example. The depth information sequences 220 may comprise a plurality of depth image sequences 220₁-220_{M}. The depth image sequences 220₁-220ₘ may comprise corresponding depth information captured at different view angles θ₁ . . . θ_{M} by the monoscopic video camera array 110 for the captured 2D monoscopic video. The 2D video 210 and the depth information sequences 220 may become input to the video processor 230.

The video processor 230 may be substantially similar to the video processor 120 FIG. 1. The video processor 230 may comprise a multi-view coding (MVC) encoder 232. The MVC encoder 232 may comprise suitable logic, circuitry, interfaces and/or code that may be operable to utilize MVC to compress or encode the 2D video 210 and the depth information sequences 220, frame-by-frame, into a compressed 2D video and compressed depth information sequences, respectively, for transmission. The MVC encoder 232 may utilize dependencies between the 2D video 210 and the depth information sequences 220 to increase or improve the coding efficiency. The video transcoder 233 may comprise suitable logic, circuitry, interfaces and/or code that may be operable to convert or transcode the compressed 2D video and the compressed depth information sequences from the MVC encoder 232 into Blu-ray Disc (BD) format. More specifically, the video transcoder 233 may convert the compressed 2D video into a Blu-ray left view stream, and may convert the compressed depth information sequences into a Blu-ray right view stream, respectively. The Blu-ray left view stream and the Blu-ray right view stream may be provided or communicated to the video rendering processor 240 for 3D video rendering. The video transcoder 233 may be integrated to the video processor 230 internally or externally.

The video rendering processor 240 may be substantially similar to the video rendering processor 136a FIG. 1. The video rendering processor 240 may comprise a MVC decoder 242. The MVC decoder 242 may comprise suitable logic, circuitry, interfaces and/or code that may be operable to decode or decompress the Blu-ray left view stream and the Blu-ray right view stream from the video transcoder 233 frame-by-frame. In this regard, the decompressed Blu-ray left view stream may comprise content estimated for the captured 2D monoscopic video. The decompressed Blu-ray right view stream may comprise content estimated for the captured corresponding depth information at the different view angles θ₁ . . . θ_{M} for the captured 2D monoscopic video. Depending on display configuration and/or user preferences, the video rendering processor 240 may create a single-view 3D video and/or a multi-view 3D video from the estimated 2D monoscopic video and the estimated corresponding depth information at the different view angles θ₁ . . . θ_{M}. In instances where a single view 3D video is preferred for a specific view angle out of the different view angles θ₁ . . . θ_{M}, the video rendering processor 240 may extract or select depth information corresponding to the specific view angle from the estimated corresponding depth information at the view angles θ₁-θ_{M} for the captured 2D monoscopic video. The extracted depth information for the specific view angle may be combined with the estimated 2D monoscopic video to compose or create a single view 3D video for the specific view angle. The resulting single view 3D video may be displayed by the 3D display device 250.

In instances where a multi-view 3D video is preferred for multiple specific view angles out of the view angles θ₁-θ_{M}, the video rendering processor 240 may be operable to extract or select depth information related to the multiple specific view angles from the estimated corresponding depth information at the view angles θ₁-θ_{M} for the captured 2D monoscopic video. The extracted depth information for the multiple specific view angles may be combined with the estimated 2D monoscopic video to compose or create a multi-view 3D video for the multiple specific view angles. The resulting 3D video may be displayed by the 3D display device 250 and simultaneously provide multiple 3D effects for the same estimated 2D monoscopic video on the single 3D display device 250.

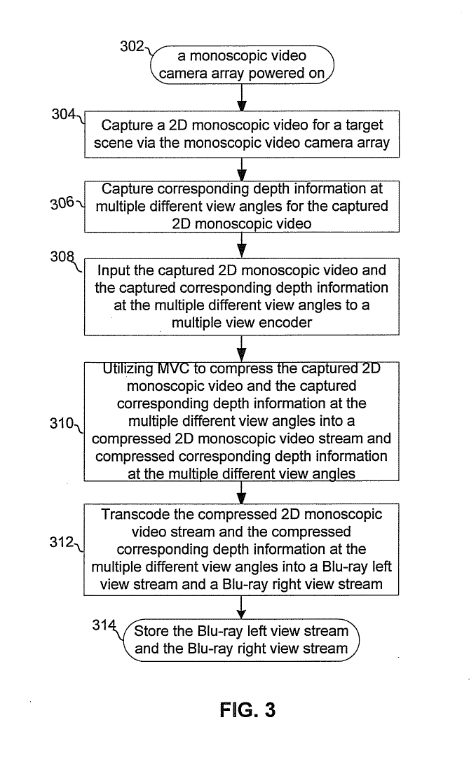

FIG. 3 is a flow chart illustrating exemplary steps that may be performed to compress a 2D monoscopic video and corresponding depth information captured at different view angles utilizing multi-view video coding (MVC), in accordance with an embodiment of the invention. Referring to FIG. 3, the exemplary steps may begin with step 302, in which the monoscopic video camera array 110 is powered on. In step 304, the monoscopic video camera array 110 may be operable to capture a 2D monoscopic video for a target scene. In step 306, the monoscopic video camera array 110 may capture corresponding depth information for the captured 2D monoscopic video at different view angles θ₁ . . . θ_{M}. In step 308, the captured 2D monoscopic video and the captured corresponding depth information at the multiple different view angles may input to the MVC encoder 232. In step 310, the MVC encoder 232 may utilize MVC to compress the captured 2D monoscopic video and the captured corresponding depth information at the multiple different view angles into a compressed 2D monoscopic video and compressed corresponding depth information at the multiple different view angles. In step 312, the video transcoder 233 may transcode the compressed 2D monoscopic video into a Blu-ray left view stream, and may transcode the compressed corresponding depth information at the multiple different view angles into a Blu-ray right view stream, respectively. In step 314, the Blu-ray left view stream and the Blu-ray right view stream may be stored into memory 134.

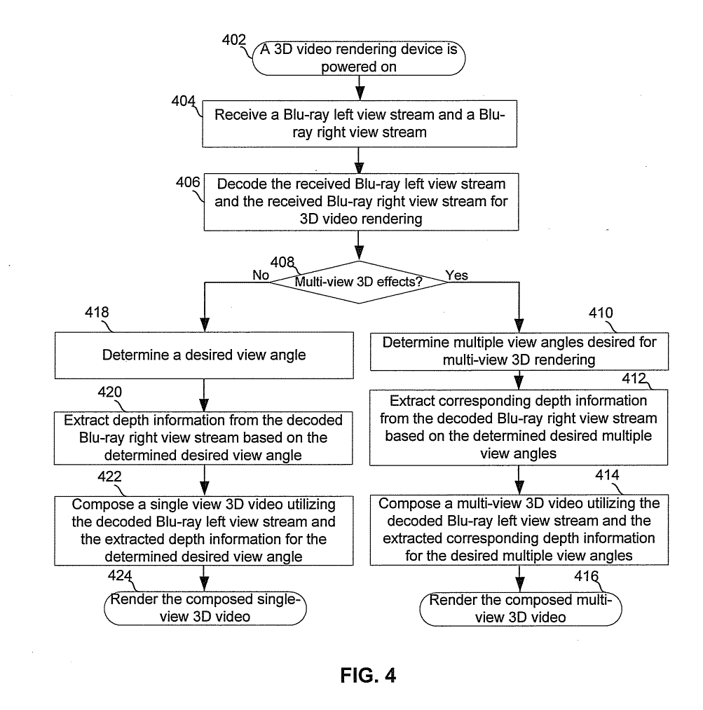

FIG. 4 is a flow chart illustrating exemplary steps that may be performed for multi-view 3D video rendering, in accordance with an embodiment of the invention. Referring to FIG. 4, the exemplary steps may begin with step 402, in which the 3D video rendering device 136 is powered on. In step 404, the 3D video rendering device 136 may be operable to receive a Blu-ray left view stream and a Blu-ray right view stream from the video transcoder 233. In step 406, the MVC decoder 242 may be operable to decode the received Blu-ray left view stream and the received Blu-ray right view stream for 3D video rendering. In step 408, it may be determined whether multi-view 3D effects are desired for 3D video rendering. In instances where multi-view 3D effects are desired for 3D video rendering, then in step 410, the 3D video rendering device 136 may determine multiple view angles preferred for multi-view 3D rendering. In step 412, the 3D video rendering device 136 may extract or select depth information from the decoded Blu-ray right view stream based on the determined multiple view angles. In step 414, the decoded Blu-ray left view stream and the extracted corresponding depth information for the determined multiple view angles may be combined to form or generate a multi-view 3D video for the determined multiple view angles. In step 416, the composed multi-view 3D video may be displayed or rendered for display to a user.

In step 408, in instances where multi-view 3D effects are not desired for 3D video rendering, then in step 418, the 3D video rendering device 136 may determine a single view angle preferred for single-view 3D rendering. In step 420, the 3D video rendering device 136 may extract or select depth information from the decoded Blu-ray right view stream based on the determined single view angle. In step 422, the decoded Blu-ray left view stream and the extracted corresponding depth information for the determined single view angle may be combined to form or generate a single view 3D video. In step 424, the composed single-view 3D video may be displayed or rendered for presentation to a user.

Various aspects of a method and system for multi-view 3D video rendering are provided. In various exemplary embodiments of the invention, an array of monoscopic sensing devices such as the monoscopic video camera array 110 comprises one or more image sensors and one or more depth sensors. The monoscopic video camera array 110 may be operable to capture a 2D monoscopic video via the one or more image sensors and to capture corresponding depth information, via the one or more depth sensors, at a plurality different view angles θ₁ . . . θ_{M} for the captured 2D video. The captured 2D monoscopic video and the captured corresponding depth information, at the plurality different view angles θ₁ . . . θ_{M}, may be utilized to compose a 3D video for 3D video rendering. The captured 2D monoscopic video and the captured corresponding depth information, at the plurality different view angles θ₁ . . . θ_{M}, may input to the MVC encoder 232 to be compressed utilizing MVC. The compressed 2D monoscopic video and the compressed corresponding depth information, at the plurality different view angles θ₁ . . . θ_{M}, may input to the transcoder 233 to be transcoded into a Blu-ray left view stream and a Blu-ray right view stream, respectively. The Blu-ray left view stream and the Blu-ray right view stream may be stored in the memory 134 for 3D video rendering and/or playback. In this regard, the stored Blu-ray left view stream and the stored Blu-ray right view stream may be decoded via the MVC decoder 242. Depending on display configuration and/or user preferences, a single view 3D video and/or a multi-view 3D video may be composed or created from the decoded Blu-ray left view stream and the decoded Blu-ray right view stream. In instances where a single view 3D video for a specific view angle out of the view angles θ₁-θ_{M} is preferred, the video rendering processor 240 may be operable to extract depth information corresponding to the specific view angle from the decoded Blu-ray right view stream.

The video rendering processor 240 may combine the decoded Blu-ray left view stream with the extract depth information to compose a single view 3D video for the specific view angle. In instances where a multi-view 3D video for two or more specific view angles out of out of the view angles θ₁-θ_{M} are preferred, the video rendering processor 240 may be operable to extract depth information corresponding to the specific two or more view angles from the decoded Blu-ray right view stream. The video rendering processor 240 may combine the decoded Blu-ray left view stream with the extract depth information to compose a multi-view 3D video for the specific two or more view angles. The composed 3D video may be rendered for display by the 3D display device 250.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for multi-view 3D video rendering.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing signals, the method comprising:
in an array of monoscopic sensing devices comprising one or more image sensors and one or more depth sensors:
capturing a two-dimensional video and corresponding depth information at a plurality different view angles; and
composing a three-dimensional video utilizing said captured two-dimensional video and said captured corresponding depth information at said plurality different view angles.

2. The method of claim 1, comprising compressing said captured two-dimensional video and said captured corresponding depth information at said plurality different view angles utilizing multi-view coding.

3. The method of claim 2, comprising transcoding said compressed two-dimensional video and said compressed depth information at said plurality different view angles into a Blu-ray left view stream and a Blu-ray right view stream, respectively.

4. The method of claim 3, comprising storing said Blu-ray left view stream and said Blu-ray right view stream.

5. The method of claim 4, comprising:
decoding said stored Blu-ray left view stream and said stored Blu-ray right view stream; and
composing said three-dimensional video utilizing said decoded Blu-ray left view stream and said decoded Blu-ray right view stream.

6. The method according to claim 5, comprising composing said three-dimensional video for one or more view angles out of said plurality different view angles utilizing said decoded Blu-ray left view stream and said decoded Blu-ray right view stream.

7. The method according to claim 6, comprising extracting depth information corresponding to a single view angle out of said plurality different view angles from said decoded Blu-ray right view stream for said composing.

8. The method according to claim 7, comprising:
composing said three-dimensional video for said single view angle by combining said decoded Blu-ray left view stream with said extracted depth information; and
rendering said composed three-dimensional video for said single view angle.

9. The method according to claim 6, comprising extracting depth information corresponding to two or more different view angles out of said plurality different view angles from said decoded Blu-ray right view stream for said composing.

10. The method according to claim 9, comprising:
composing said three-dimensional video for said two or more different view angles by combining said decoded Blu-ray left view stream with said extracted depth information; and
rendering said composed three-dimensional video for said two or more different view angles.

11. A system for processing signals, the system comprising:
one or more circuits for use in an array of monoscopic sensing devices comprising one or more image sensors and one or more depth sensors, said one or more circuits being operable to:
capturing a two-dimensional video and corresponding depth information at a plurality different view angles; and
composing a three-dimensional video utilizing said captured two-dimensional video and said captured corresponding depth information at said plurality different view angles.

12. The system according to claim 11, wherein said one or more circuits are operable to compress said captured two-dimensional video and said captured corresponding depth information at said plurality different view angles utilizing multi-view coding.

13. The system according to claim 12, wherein said one or more circuits are operable to transcode said compressed two-dimensional video and said compressed depth information at said plurality different view angles into a Blu-ray left view stream and a Blu-ray right view stream, respectively.

14. The system according to claim 13, wherein said one or more circuits are operable to store said Blu-ray left view stream and said Blu-ray right view stream.

15. The system according to claim 14, wherein said one or more circuits are operable to decode said stored Blu-ray left view stream and said stored Blu-ray right view stream; and compose said three-dimensional video utilizing said decoded Blu-ray left view stream and said stored Blu-ray right view stream.

16. The system according to claim 15, wherein said one or more circuits are operable to compose said three-dimensional video for one or more view angles out of said plurality different view angles utilizing said decoded Blu-ray left view stream and said stored Blu-ray right view stream.

17. The system according to claim 16, wherein said one or more circuits are operable to extract depth information corresponding to a single view angle out of said plurality different view angles from said decoded Blu-ray right view stream for said composing.

18. The system according to claim 17, wherein said one or more circuits are operable to compose said three-dimensional video for said single view angle by combining said decoded Blu-ray left view stream with said extracted depth information;
and render said composed three-dimensional video for said single view angle.

19. The system according to claim 16, wherein said one or more circuits are operable to extract depth information corresponding to two or more different view angles out of said plurality different view angles from said decoded Blu-ray right view stream for said composing.

20. The system according to claim 19, wherein said one or more circuits are operable to compose said three-dimensional video for said two or more different view angles by combining said decoded Blu-ray left view stream with said extracted depth information; and render said composed three-dimensional video for said two or more different view angles.
